(19) United States
(12) Patent Application Publication
(10) Pub. No.: US 2016/0188057 A1
(43) Pub. Date: Jun. 30, 2016

(54) IN-CELL TOUCH DISPLAY DEVICE HAVING INCREASED S/N RATIO DURING TOUCH CONTROL THEREOF

(71) Applicant: HON HAl PRECISION INDUSTRY CO., LTD., New Taipei (TW)

(72) Inventor: FENG-HSIANG LIU, Hsinchu (TW)

(21) Appl. No.: 14/714,012

(22) Filed: May 15, 2015

(30) Foreign Application Priority Data
Dec. 26, 2014 (CN) 201410823486.9

(51) Int. Cl. G06F 3/041; G06F 3/044; G09G 3/36; G02F 1/1333

(52) U.S. Cl. CPC G06F 3/0412; G02F 1/13338; G06F 3/044; G06F 3/0416; G09G 3/3696; G09G 3/3655; G09G 3/3677; G09G 3/3688; G09G 2300/0809; G09G 2300/0426

(57) ABSTRACT

An in-cell touch display device includes a touch control display panel, a common voltage generating circuitry and a detecting module. The touch control display panel has common electrodes in electrical connection with the common voltage generating circuitry and the detecting module and touch control sensing electrodes. The common voltage generating circuitry is provided for outputting a first common voltage and a second common voltage to the common electrodes in different time periods. The detecting module detects actual voltage of the common electrodes and determines a variation between the actual voltage and the first common voltage to thereby adjust the second common voltage according to the variation.

### CROSS-REFERENCE TO RELATED APPLICATIONS

This application claims priority to Chinese Patent Application No. 201410823486.9 filed on Dec. 26, 2014, the contents of which are incorporated by reference herein.

### FIELD

The subject matter herein generally relates to an in-cell touch display device, and particularly to an in-cell touch display device which has an improved signal/noise ratio during operation of touch control thereof.

### BACKGROUND

Following the advancement of computer and communication technology, in-cell display devices which can be used to both output and input information are becoming more and more popular.

An in-cell display device has common electrodes which output a first common voltage (a direct current) during display operation thereof and a second common voltage (an alternating current) during operation of touch control thereof. Since the actual output voltage of the first common voltage is easily fluctuated, it is difficult for the common electrodes to output the second common voltage stably at the designated level, whereby a signal/noise ratio during the operation of touch control is low to thereby reduce the accuracy for the touch control.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the present in-cell touch display device. Moreover, in the drawings, like reference numerals designate corresponding parts throughout the several views.

FIG. 1 is a block diagram of an in-cell touch display device in accordance with the present disclosure.

FIG. 2 is an isometric view of a touch control display panel of the in-cell touch display device of FIG. 1.

FIG. 3 is a cross-sectional view of the touch control display panel of FIG. 2, taken along line III-III thereof.

FIG. 4 is a diagrammatic top view of a driving layer of the touch control display panel of FIG. 2.

FIG. 5 is a diagrammatic top view of a common electrode layer of the touch control display panel of FIG. 2.

FIG. 6 is a diagrammatic view showing details of a touch control sensing electrode layer and the common electrode layer of the touch control display panel of FIG. 2.

FIG. 7 is a waveform obtained from common electrodes of the in-cell touch display device of FIG. 1 in a first operation mode.

FIG. 8 is a waveform obtained from the common electrodes of the in-cell touch display device of FIG. 1 in a second operation mode.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “substantially” is defined to be essentially conforming to the particular dimension, shape or other word that substantially modifies, such that the component needs not be exact. For example, substantially cylindrical means that the object resembles a cylinder, but can have one or more deviations from a true cylinder. The term “comprising” means “including, but not necessarily limited to”; it specifically indicates open-ended inclusion or membership in a so-described combination, group, series and the like.

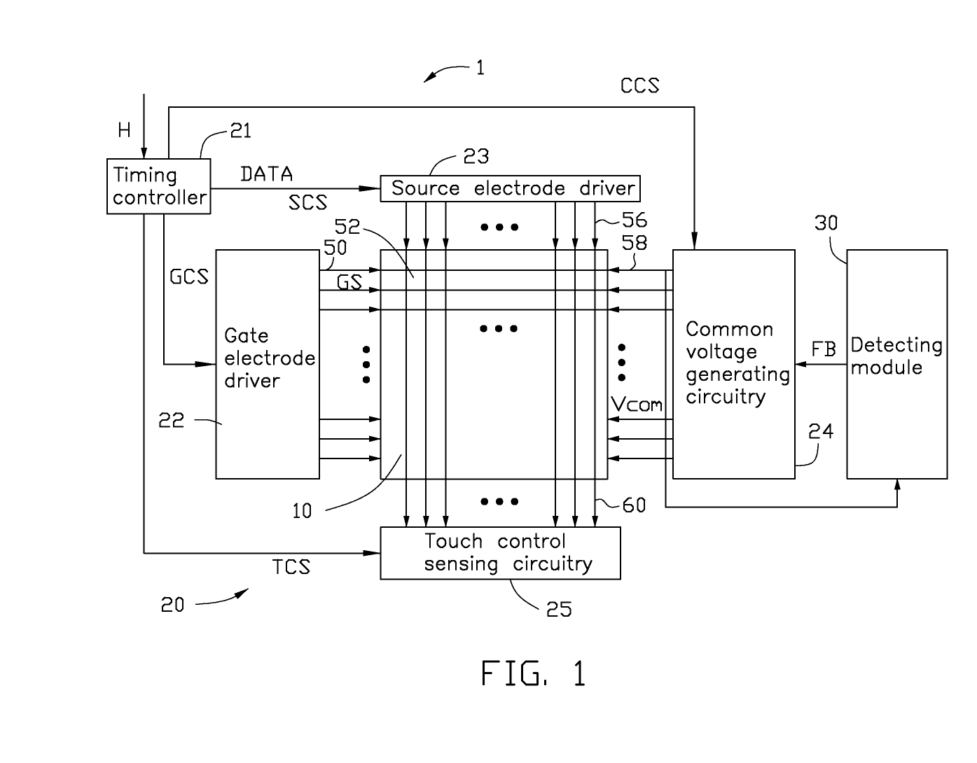

Referring to FIG. 1, a block diagram of an in-cell touch display device 1 in accordance with the present disclosure is shown. The in-cell touch display device 1 includes a touch control display panel 10, a drive circuit module 20 and a detecting module 30. The drive circuit module 20 is provided for driving the touch control display panel 10 to show pictures, and sense and identify touch control operations received by the touch control display panel 10.

The drive circuit module 20 includes a timing controller 21, a gate electrode driver 22, a source gate driver 23, a common voltage generating circuitry 24 and a touch control sensing circuitry 25.

The timing controller 21 is provided for receiving horizontal synchronization signals H from an external system (not shown) and outputting gate electrode control signals GCS to the gate electrode driver 22, source electrode control signals SCS and picture data DATA to the source electrode driver 23, common voltage control signals CCS to the common voltage generating circuitry 24, and touch control signals TCS to the touch control sensing circuitry 25.

The gate electrode driver 22 connects with, via a plurality of gate electrode lines 50, pixel units 52 of the touch control display panel 10. The gate electrode driver 22 outputs gate electrode signals GS to the pixel units 52 via the gate electrode lines 50 in accordance with the gate electrode control singles GCS to activate corresponding pixel units 52. The source electrode driver 23 connects with, via a plurality of source electrode lines 56, the pixel units 52. The source electrode driver 23 furthermore outputs picture data DATA to the pixel units 52 via the source electrode lines 56 in accordance with the source electrode control signals SCS, whereby the pixel units 52 can display the picture data DATA.

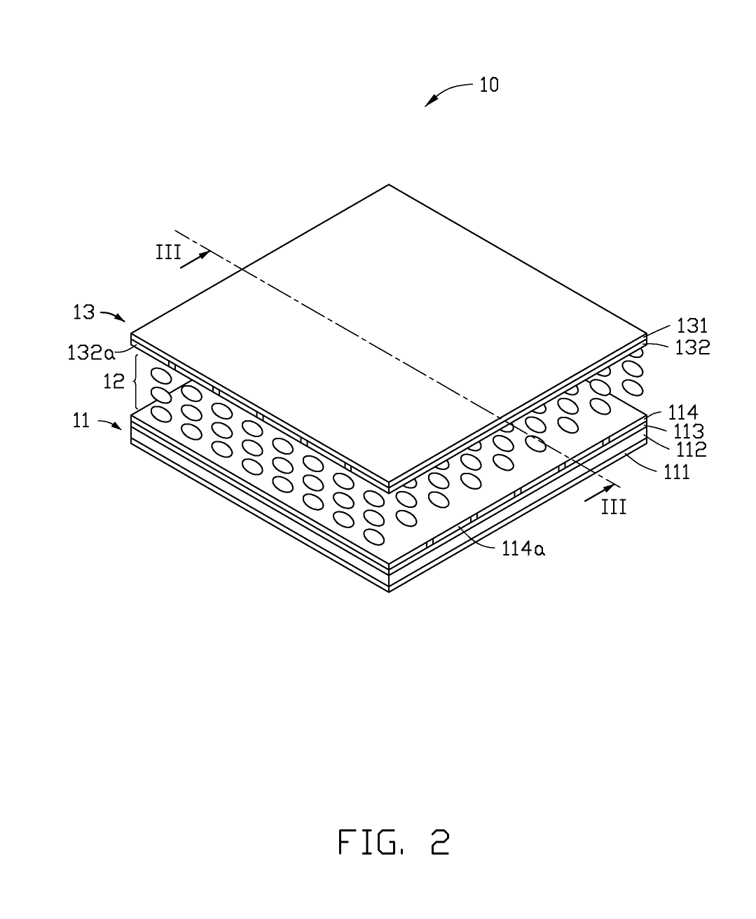

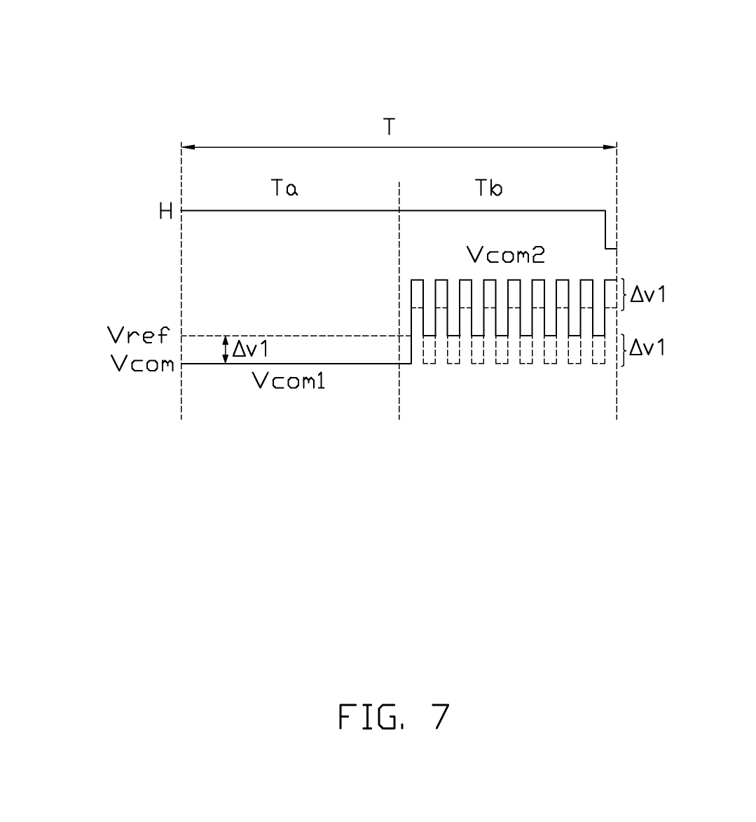

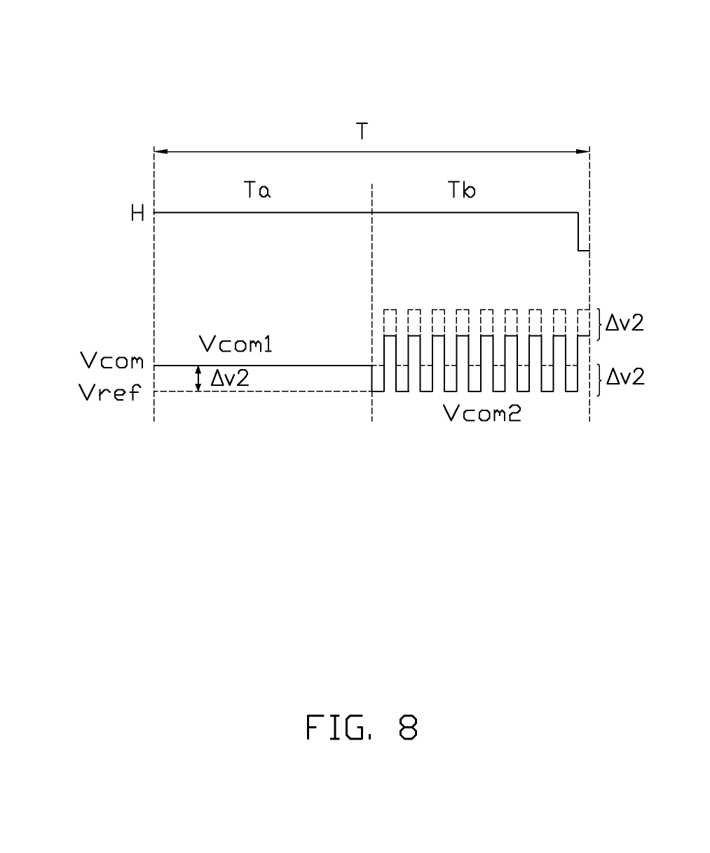

The common voltage generating circuitry 24 connects with, via a plurality of common electrode lines 58, common electrodes 114a (FIG. 2) of the touch control display panel 10. The common voltage generating circuitry 24 is provided for generating common voltage Vcom under control of the common voltage control signals CCS. In accordance with the present disclosure, the common voltage Vcom includes a first common voltage Vcom1 for a first time period and a second common voltage Vcom2 for a second time period (referring to FIGS. 7 and 8). The first common voltage Vcom1 is related to a direct current having a first voltage which is applied to the common electrodes 114a when the in-cell touch display device 1 displays pictures. In accordance with the preferred embodiment, the first common voltage Vcom1 is 0V. The second common voltage Vcom2 is related to an alternating current having a second voltage alternated with a third voltage. The second common voltage Vcom2 is used for being applied to the common electrodes 114a when the in-cell touch display device 1 is used to sense touch control operations to the touch control display panel 10. Preferably, the second voltage, similar to the first common voltage Vcom1, is 0V, while the third voltage is 3.5V.

The touch control sensing circuitry 25 connects with, via a plurality of sensing lines 60, a plurality of touch control sensing electrodes 132a (referring to FIG. 2). The touch control sensing circuitry 25 receives sensing signals TS generated by a user's touch of the touch control display panel 10. Furthermore, the touch control sensing circuitry 25 identifies coordinates of positions of the touches acting on the touch control display panel 10 by processing and analyzing the sensing signals TS by, for example, an analogue/digital signal conversion.

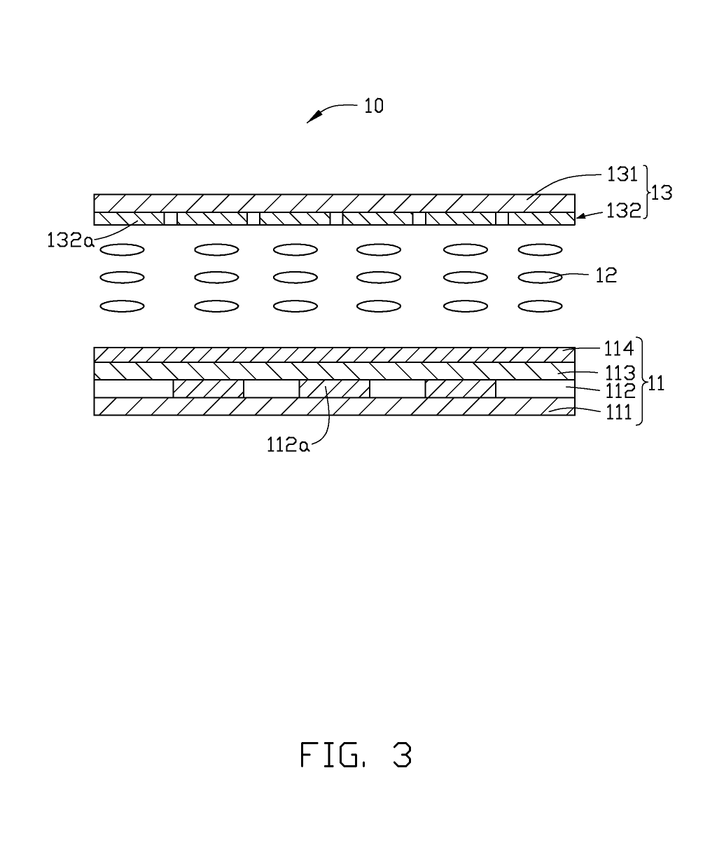

FIG. 2 shows a perspective view of the touch control display panel 10 of FIG. 1, while FIG. 3 shows a cross-sectional view thereof, taken along line of FIG. 2. The touch control display panel 10 is provided for showing pictures and sensing touch operations at different time periods in a time-sharing manner. The touch control display panel 10 includes a first substrate 11, a second substrate 13 over the first substrate 11 and a liquid crystal layer 12 sandwiched between the first and second substrates 11, 13.

The first substrate 11 is a matrix substrate and consists of, along an upward direction, a first base 111, a driving layer 112, an insulating layer 113 and a common electrode layer 114. The driving layer 112 is located over the first base 111 and includes a plurality of pixel electrodes 112a arranged in a matrix. The insulating layer 113 covers a top face of the driving layer 112. The common electrode layer 114 is located over a top face of the insulating layer 113 and includes the plurality of common electrodes 114a. The pixel electrodes 112a and the common electrodes 114 generate electric field (not shown) across the liquid crystal layer 12 to cause liquid crystal molecules in the liquid crystal layer 12 to twist to thereby show the pictures.

The second substrate 13 is a color filter substrate which consists of a second base 131 and a touch control sensing electrode layer 132. The touch control sensing electrode layer 132 includes a plurality of touch control sensing electrodes 132a which are spaced from each other by a predetermined distance along a horizontal direction. The touch control sensing electrode layer 132 is located between the second base 131 and the liquid crystal layer 12, for receiving a user's touch control operation. The touch control sensing electrodes 132a, in cooperation with the common electrodes 114a, detect the touch control operation and identify the position of coordinates of the touch control operation on the touch control display panel 10.

In the preferred embodiment, the first and second bases 111, 131 can be made of transparent glass or plastic. The pixel electrodes 112a, the common electrodes 114a and the touch control sensing electrodes 132a can be made of indium tin oxide (ITO) or indium zinc oxide (IZO).

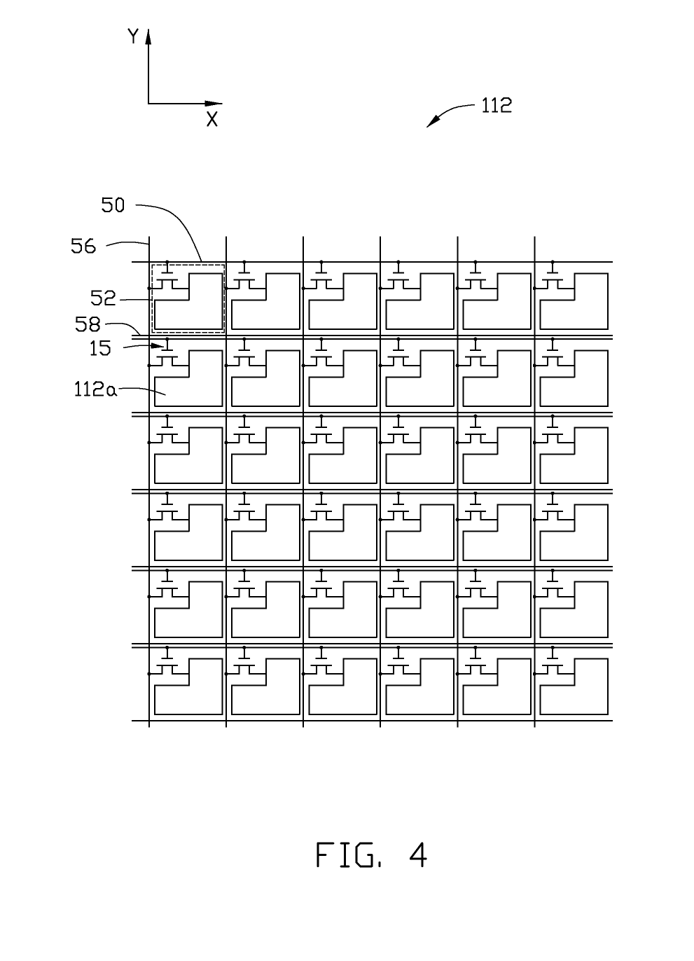

Referring to FIG. 4, it is a diagrammatic top view of the driving layer 112 of the touch control display panel 10. The driving layer 112 includes the plurality parallel gate electrode lines 50, the plurality of parallel source electrode lines 56 which are perpendicular to the gate electrode lines 50 and electrically insulating therefrom, and the plurality of parallel common electrode lines 58 which are parallel to the gate electrode lines 50 and electrically insulating from the gate electrode lines 50 and source electrode lines 56. The gate electrode lines 50, source electrode lines 56 and common electrode lines 58 cooperatively define a plurality of rectangular regions arranged in a matrix. Each region receives a corresponding pixel unit 52 therein. Each pixel unit 52 includes a thin film transistor (TFT) 15 and a corresponding pixel electrode 112a in electrically coupling with the thin film transistor 15. The gate electrode lines 50 and the common electrode lines 58 extend along a first direction X, while the source electrode lines 56 extend along a second direction Y which is perpendicular to the first direction X.

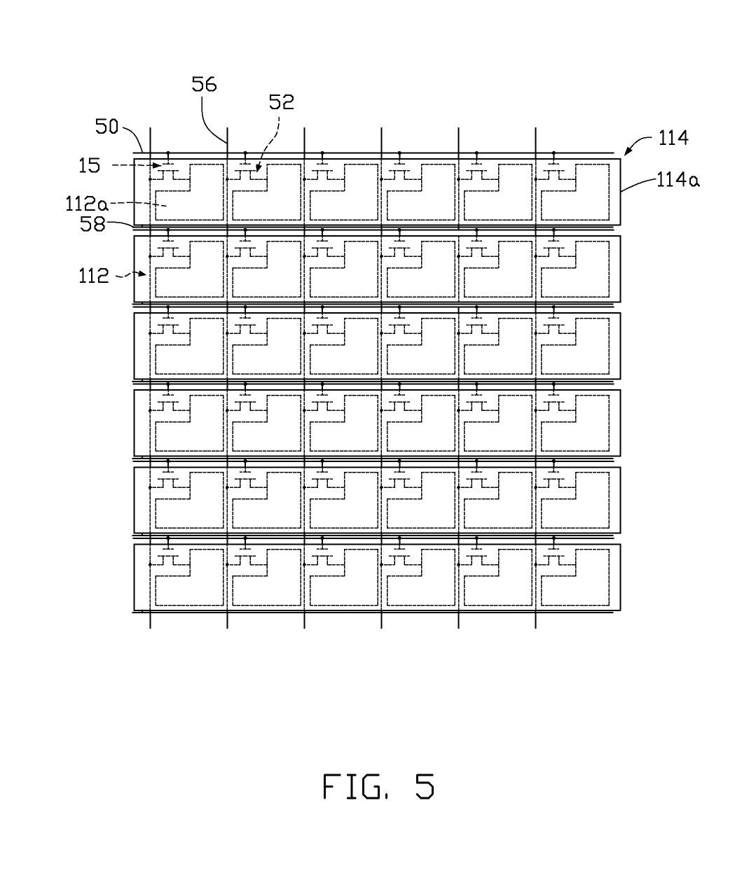

Referring to FIG. 5, it is a diagrammatic top view of the common electrode layer 114 in which the driving layer 112 is also shown to illustrate the relative relationship between the common electrodes 114a and the driving layer 112. The pixel units 52 in each row of the driving layer 112 are located corresponding to one common electrode 114a. In other words, each common electrode 114a covers a corresponding row of the pixel units 52, and an amount of the common electrodes 114a is equal to an amount of the rows of the pixel units 52. Each common electrode 114a electrically couples with a corresponding common electrode line 58. In the preferred embodiment, each common electrode 114a has a shape of a substantially elongated rectangle.

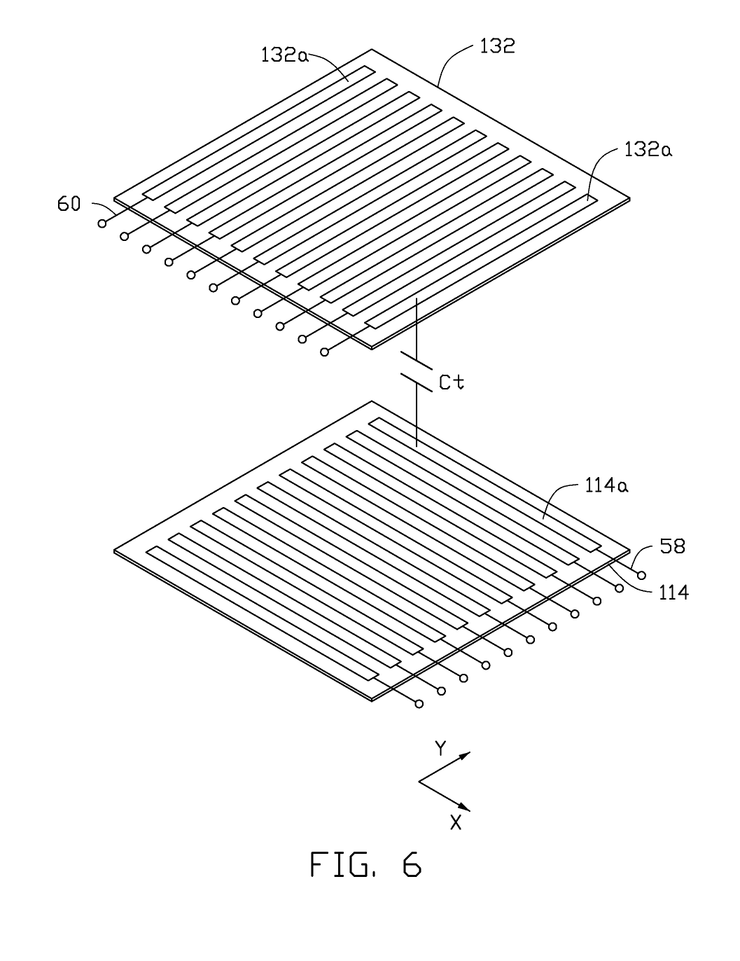

Referring to FIG. 6, it is a perspective view showing details of the common electrode layer 114 and the touch control sensing electrode layer 132. The common electrodes 114a of the common electrode layer 114 are arranged parallel to each other along the second direction Y and equidistantly spaced and insulating from each other. The touch control sensing electrodes 132a of the touch control sensing electrode layer 132 are arranged parallel to each other along the first direction X and equidistantly spaced and insulating from each other. In other words, the common electrodes 114a and the touch control sensing electrodes 132a are perpendicular to and insulating from each other. In the preferred embodiment, like the common electrodes 114a, each touch control sensing electrode 132a has a shape of a substantially elongated rectangle. When the common electrodes 114a are applied with a corresponding voltage, a sensing capacitance Ct is formed between the common electrodes 114a and the touch control sensing electrodes 132a and an electric field (not shown) is formed. Thus, the touch control display panel 10 can sense external touch operation thereto.

Referring back to FIG. 1, the detecting module 30 electrically couples with the common voltage generating circuitry 24 and the common electrodes 114a. The detecting module 30 detects an actual voltage Vref (FIGS. 7 and 8) of the common electrodes 114a at the first time period and outs a feedback signal FB to the common voltage generating circuitry 24. The common voltage generating circuitry 24 outputs the first common voltage Vcom1 (FIGS. 7 and 8) and the second common voltage Vcom2 (FIGS. 7 and 8) to corresponding common electrodes 114a via the common electrode lines 58. When the detecting module 30 detects that there is a variation between the actual voltage Vref and the first common voltage Vcom1 during the first time period, the common voltage generating circuitry 24 adjusts the second common voltage Vcom2.

In more detail, when the detecting module 30 detects that during the first time period the actual voltage Vref of the common electrodes 114a is larger than the first voltage of the first common voltage Vcom1 for a first variation Δv1, the detecting module 30 outputs a first feedback signal to the common voltage generating circuitry 24. The common voltage generating circuitry 24 increases the second common voltage Vcom2 according to the first variation Δv1 by increasing each of the second and third voltages of the second common voltage Vcom2 with the first variation Δv1. In other hand, when the detecting module 30 detects that during the first time period the actual voltage Vref of the common electrodes is smaller than the first voltage of the first common voltage Vcom1 for a second variation Δv2, the detecting module 30 outputs a second feedback signal to the common voltage generating circuitry 24. The common voltage generating circuitry 24 decreases the second common voltage Vcom2 according to the second variation Δv2 by decreasing each of the second and third voltages of the second common voltage Vcom2 with the second variation Δv2. In accordance with the preferred embodiment, the first voltage is the standard voltage of the first common voltage Vcom1 of the in-cell touch display device 1.

Referring to FIGS. 7 and 8, they are related to waveforms of the common voltage for driving the in-cell touch display device 1, wherein H represents a waveform of the horizontal synchronization signal received by the timing controller 21. The horizontal synchronization signal includes a plurality of continuous, horizontally driving cycles T. Each horizontal driving cycle T means the time period for accomplishing loading picture data DATA and touch control sensing over a horizontal direction of a touch control sensing region. The time period of the horizontal driving cycle T is assumed as 1H. In other words, for a horizontal driving cycle T, the common electrodes 114a are seamlessly and sequentially subjected to loading of the first and second common voltages, Vcom1 & Vcom2. Each horizontal driving period T includes a first time period Ta and a second time period Tb. There is no overlap between the first and second time periods Ta, Tb. In the preferred embodiment, the time period 1H is 16.7 ms.

During the first time period Ta, the in-cell display device 1 is under a time period for showing the pictures, wherein the common voltage generating circuitry 24 outputs the first common voltage Vcom1 to corresponding common electrodes 114a via the common electrode lines 58. During the first time period Ta, the detecting module 30 detects the variation of the actual voltage Vref of the common electrodes 114a relative to the first voltage of the first common voltage Vcom1 and generates a corresponding feedback signal FB to the common voltage generating circuitry 24. When the detecting module 30 detects that the actual voltage Vref of the common electrodes 114a is larger than the first voltage of the first common voltage Vcom1 for the first variation Δv1 as shown in FIG. 7, the detecting module 30 generates a first feedback signal to the common voltage generating circuitry 24. When the detecting module 30 detects that the actual voltage Vref of the common electrodes 114a is smaller than the first voltage of the first common voltage Vcom1 for the second variation Δv2 as shown in FIG. 8, the detecting module 30 outputs a second feedback signal to the common voltage generating circuitry 24.

During the second time period Tb, the in-cell touch display device 1 is under a touch control operation period, wherein the common voltage generating circuitry 24 outputs the second common voltage Vcom2 to the common electrodes 114a via the common electrode lines 58. In the second time period Tb, the common voltage generating circuitry 24 adjusts the second common voltage Vcom2. In more details, in accordance with the first feedback signal, the common voltage generating circuitry 24 increases the second common voltage Vcom2, i.e., increasing each of the second and third voltages of the second common voltage Vcom2 by the first variation Δv1, as shown in FIG. 7. On the other hand, in accordance with the second feedback signal, the common voltage generating circuitry 24 decreases the second common voltage Vcom2, i.e., decreasing each of the second and third voltages of the second common voltage Vcom2 by the second variation ≢v2, as shown in FIG. 8.

In accordance with the present disclosure, the second common voltage Vcom2 is adjusted in accordance with a variation of the first common voltage Vcom1 output by the common voltage generating circuitry 24 and the actual voltage Vref measured by the detecting module 30 from the common electrodes 114a, the SIN (signal-to-noise ratio) of the in-cell touch display device 1 during the touch control operation in the second time period Tb can be improved. Accordingly, accuracy of the operation of the touch control can be enhanced.

It is to be understood that the above-described embodiments are intended to illustrate rather than limit the disclosure. Variations may be made to the embodiments without departing from the spirit of the disclosure as claimed. The above-described embodiments illustrate the scope of the disclosure but do not restrict the scope of the disclosure.

What is claimed is:

1. An in-cell touch display device comprising:
a touch control display panel having common electrodes;
a common voltage generating circuitry electrically coupled to the common electrodes of the touch control display panel and configured to output a first common voltage and a second common voltage to the common electrodes at different time periods; and
a detecting module configured to detect an actual voltage of the common electrodes and determine a variation between the actual voltage and the first common voltage to adjust the second common voltage according to the variation.

2. The in-cell touch display device 1, wherein the first common voltage is related to a direct current having a first voltage and the second common voltage is related to an alternating current having a second voltage and a third voltage, wherein when the actual voltage is larger than the first voltage of the first common voltage, each of the second and third voltages of the second common voltage is added with the variation, and wherein when the actual voltage is smaller than the first voltage of the first common voltage, each of the second and third voltages of the second common voltage is reduced by the variation.

3. The in-cell touch display device of claim 2, wherein the different time periods include a first time period during which the touch control display panel shows pictures, the common voltage generating circuitry generates the first common voltage and the detecting module detects the actual voltage of the common electrodes and a second time period during which the touch control display panel receives a touch control operation thereto and the common voltage generating circuitry outputs the second common voltage.

4. The in-cell touch display device of claim 3, wherein the touch control display panel further comprises a first base, a driving layer located over the first base and including a plurality of pixel electrodes, an insulating layer over the driving layer, a common electrode layer located over the insulating layer and including the plurality of common electrodes, a liquid crystal layer over the common electrode layer, a touch control sensing layer located over the liquid crystal layer and including a plurality of touch control sensing electrodes and a second base over the touch control sensing layer, wherein the touch control display panel shows the pictures when the pixel electrodes and the common electrodes generate an electric field across the liquid crystal layer, and wherein the touch control display panel receives the touch control operation when the common electrodes and the touch control sensing electrodes form a sensing capacitance therebetween.

5. The in-cell touch display device of claim 4, further comprising a timing controller, a source electrode driver in electrical connection with the touch control display panel, a gate electrode driver in electrical connection with the touch control display panel and a touch control sensing circuitry in electrical connection with the touch control display panel, wherein the timing controller receives horizontal synchronization signals and outputs gate electrode control signals to the gate electrode driver, source electrode control signals and picture data to the source electrode driver, common voltage control signals to the common voltage generating circuitry, and touch control signals to the touch control sensing circuitry.

6. The in-cell touch display device of claim 5, wherein the driving layer of the touch control display panel further comprises a plurality of thin film transistors which cooperates with the pixel electrodes to form a plurality of pixel units, the source electrode driver electrically connecting with the pixel units via a plurality of source electrode lines, the gate electrode driver electrically connecting with the pixel units via a plurality of gate electrode lines, the touch control sensing circuitry electrically connecting with the touch control sensing electrodes via a plurality of sensing lines and the common voltage generating circuitry electrically connecting with the common electrodes via a plurality of common electrode lines.

7. An in-cell touch display device comprising:
a touch control display panel for showing pictures and receiving a touch control operation, having a plurality of common electrodes;
a common voltage generating circuitry electrically coupled to the common electrodes of the touch control display panel and configured to output a first common voltage and a second common voltage to the common electrodes of the touch control display panel at different time periods;
a timing controller;
a source electrode driver in electrical connection with the touch control display panel;
a gate electrode driver in electrical connection with the touch control display panel;
a touch control sensing circuitry in electrical connection with the touch control display panel, wherein the timing controller receives horizontal synchronization signals and outputs gate electrode control signals to the gate electrode driver, source electrode control signals and picture data to the source electrode driver, common voltage control signals to the common voltage generating circuitry, and touch control signals to the touch control sensing circuitry; and
a detecting module configured to detect an actual voltage of the common electrodes and determine a variation between the actual voltage and the first common voltage to adjust the second common voltage according to the variation.

8. The in-cell touch display device of claim 7, wherein the first common voltage is related to a direct current having a first voltage and the second common voltage is related to an alternating current having a second voltage and a third voltage, wherein when the actual voltage is larger than the first voltage of the first common voltage, each of the second and third voltages of the second common voltage is added with the variation, and wherein when the actual voltage is smaller than the first voltage of the first common voltage, each of the second and third voltages of the second common voltage is reduced by the variation.

9. The in-cell touch display device of claim 8, wherein the different time periods include a first time period during which the touch control display panel shows pictures, the common voltage generating circuitry generates the first common voltage and the detecting module detects the actual voltage of the common electrode and a second time period during which the touch control display panel receives the touch control operation thereto and the common voltage generating circuitry outputs the second common voltage.

10. The in-cell touch display device of claim 9, wherein the touch control display panel further comprises a first base, a drive layer located over the first base and including a plurality of pixel electrodes, an insulating layer over the driving layer, a common electrode layer located over the insulating layer and including the plurality of common electrodes, a liquid crystal layer over the common electrode layer, a touch control sensing layer located over the liquid crystal layer and including a plurality of touch control sensing electrodes and a second base over the touch control sensing layer, wherein the touch control display panel shows the pictures when the pixel electrodes and the common electrodes generate an electric field across the liquid crystal layer, and wherein the touch control display panel receives the touch control operation when the common electrodes and the touch control sensing electrodes form a sensing capacitance therebetween.
